(19) United States
(12) Patent Application Publication
(10) Pub. No.: US 2025/0261045 A1
(43) Pub. Date: Aug. 14, 2025

(54) MANAGING QOS DIFFERENTIATION FOR NON-3GPP DEVICES CON-NECTED BEHIND A 5G-RG OR A UE IN A COMMUNICATION NETWORK

(71) Applicant: Samsung Electronics Co., Ltd., Suwon-si (KR)

(72) Inventors: Ashok Kumar NAYAK, Bangalore (IN); Varini GUPTA, Bangalore (IN)

(21) Appl. No.: 19/054,372

(22) Filed: Feb. 14, 2025

(30) Foreign Application Priority Data
Feb. 14, 2024 (IN) 202441010246
Jan. 28, 2025 (IN) 202441010246

(51) Int. Cl. H04W 28/24

(52) U.S. Cl. CPC H04W 28/24

(57) ABSTRACT

The disclosure relates to a 5G or 6G communication system for supporting a higher data transmission rate. Embodiments herein provide a method and system for managing QoS differentiation for non-3GPP devices connected behind a 5G-RG or a UE. The method includes receiving PDU session request message from a UE or an AMF and detecting whether a policy control request trigger is met. The method includes detecting at least one of a PCF node and a UPF node of a second network apparatus which supports QoS differentiation. Further, the method includes selecting at least one of the PCF node and the UPF node of the second network apparatus based on the non-3GPP device identifier, upon detection of the policy control request trigger. Further, the method includes transmitting the non-3GPP device identifier and the user plane address of the non-3GPP device to at least one of the PCF node and UPF node.

### CROSS-REFERENCE TO RELATED APPLICATIONS

This application is based on and claims priority under 35 U.S.C. § 119 to Indian patent application Ser. No. 20/244,1010246 filed on Feb. 14, 2024, and Indian patent application Ser. No. 20/244,1010246 filed on Jan. 28, 2025, both filed in the Indian Intellectual Property Office, the disclosures of which are incorporated by reference herein in their entirety.

### BACKGROUND

### 1. Field

The present disclosure is related to the field of wireless communication. More particularly, the present disclosure is related to managing quality of service (QOS) differentiation for non-3rd generation partnership project (3GPP) devices connected behind a 5^{th} generation (5G)-residential gateway (RG) or a user equipment (UE) in a communication network.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In the context of 3rd generation partnership project (3GPP) standards, a clause has been established regarding the connectivity of multiple non-3GPP devices through a single UE or a 5G-RG. This clause addresses the need for the network to effectively manage and differentiate the services provided to each of these connected devices. When several non-3GPP devices, such as internet of things (IoT) sensors, smart home appliances, or other types of connected equipment, are linked to a single UE or a 5G-RG, it becomes important for the network to recognize and treat each non-3GPP device according to its specific service requirements and capabilities. Thus, there is a need for a solution to understand how these non-3GPP devices will get differentiated services from the network.

Hence, is desirable to address the above mentioned problems and disadvantages or at least provide a useful alternative.

### SUMMARY

The principal object of the embodiments herein is to provide a system and method for managing QoS differentiation for non-3GPP devices connected behind a 5G-RG or a UE.

Another object of the embodiments herein is to provide a system and method for identifying a user and then provide differential treatment for the same service based on the user identifier.

Yet another object of the embodiments herein is to address the scenario of network function (NFs), which are responsible for providing differentiated services that may get a policy for the corresponding user identifier and then apply the policy.

In an aspect, the objectives are achieved by providing a method for managing QoS differentiation for non-3GPP devices connected behind a 5G-RG or a UE. The method includes receiving a protocol data unit (PDU) session request message from a UE or an access and mobility management function (AMF). The PDU session request message includes a non-3GPP device identifier and a user plane address of at least one non-3GPP device of a plurality of non-3GPP devices associated with the UE. Further, the method includes detecting whether a policy control request trigger is met. Further, the method includes detecting at least one of a policy control function (PCF) node and a user plane function (UPF) node of a second network apparatus which supports QOS differentiation. Further, the method includes selecting at least one of a policy control function (PCF) node and a user plane function (UPF) node of a second network apparatus based on the non-3GPP device identifier, upon detection of the policy control request trigger. Further, the method includes transmitting the non-3GPP device identifier and the user plane address of the non-3GPP device to at least one of the PCF node and UPF node.

In another aspect, the objectives are achieved by providing a method for managing QoS differentiation for non-3GPP devices connected behind a 5G-RG or a UE in a communication network. The method includes receiving a non-3GPP device identifier of at least one non-3GPP device of a plurality of non-3GPP devices connected behind the UE or the 5G-RG from a first network apparatus. Further, the method includes generating one or more PCC rules based on the at least one non-3GPP device identifier. Further, the method includes transmitting the one or more PCC rules to the first network apparatus to enable QoS handling of traffic to and from the at least one non-3GPP device associated with the UE or the 5G-RG.

In another aspect, the objectives are achieved by providing a first network apparatus for managing a QoS for a non-3GPP device in a communication network. The first network apparatus includes a first processor, a first memory coupled to the first processor, and a first differentiated service controller communicatively coupled to the first memory and the first processor. The first differentiated service controller receives a PDU session request message from a UE or an AMF. The PDU session request message includes a non-3GPP device identifier and a user plane address of at least one non-3GPP device of a plurality of non-3GPP devices associated with the UE. Further, the first differentiated service controller detects whether a policy control request trigger is met. Further, the first differentiated service controller detects at least one of a PCF node and a UPF node of a second network apparatus which supports QoS differentiation. Further, the first differentiated service controller selects at least one of a PCF node and a UPF node of a second network apparatus based on the non-3GPP device identifier, upon detection of the policy control request trigger. Further, the first differentiated service controller transmits the non-3GPP device identifier and the user plane address of the non-3GPP device to at least one of the PCF node and UPF node.

In another aspect, the objectives are achieved by providing a second network apparatus for managing a QoS for a non-3GPP device in a communication network. The second network apparatus includes a second processor, a second memory coupled to the second processor, and a second differentiated service controller communicatively coupled to the second memory and the second processor. The second differentiated service controller receives a non-3GPP device identifier of at least one non-3GPP device of a plurality of non-3GPP devices connected behind the UE or the 5G-RG from a first network apparatus. Further, the second differentiated service controller generates one or more PCC rules based on the at least one non-3GPP device identifier. Further, the second differentiated service controller transmits the one or more PCC rules to the first network apparatus to enable QoS handling of traffic to and from the at least one non-3GPP device associated with the UE or the 5G-RG.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications be made within the scope of the embodiments herein.

Embodiments of the present disclosure provides methods and apparatus for managing QoS differentiation for non-3GPP connected behind a 5G-RG or a UE.

According to the disclosure, multiple non-3GPP devices connected behind a 5G-RG or a UE can get differentiated service from the network based on identifiers of the non 3GPP devices.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

These and other features, aspects, and advantages of the present embodiments are illustrated in the accompanying drawings, throughout which like reference letters indicate corresponding parts in the various figures. The embodiments herein will be better understood from the following description with reference to the drawings, in which:

FIG. 1 illustrates a first network apparatus according to an embodiment as disclosed herein.

FIG. 2 illustrates a second network apparatus according to an embodiment as disclosed herein.

FIG. 3 illustrates a procedure executed by 5GC ensuring that differentiated services are provided based on the user identifier according to an embodiment as disclosed herein.

FIG. 4 illustrates a method for managing a QoS for a non-3GPP device in a communication network by the first network apparatus according to an embodiment as disclosed herein.

FIG. 5 illustrates a method for managing a QoS for a non-3GPP device in a

communication network by the second network apparatus according to an embodiment as disclosed herein.

### DETAILED DESCRIPTION

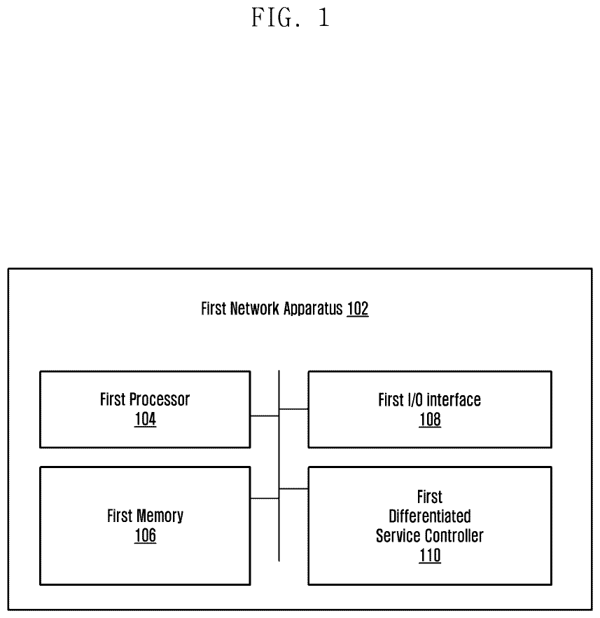

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with a plurality of other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is existing in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits, and the like, and optionally be driven by firmware and software. The circuits, for example, be embodied in a plurality of semiconductor chips, or on substrate supports such as printed circuit boards, and the like. The circuits constituting a block be implemented by dedicated hardware, or by a processor (e.g., a plurality of programmed microprocessors and associated circuitry), or by a combination of dedicated hardware to perform some functions of the block and a processor to perform other functions of the block. Each block of the embodiments be physically separated into two or more interacting and discrete blocks without departing from the scope of the provided method. Likewise, the blocks of the embodiments be physically combined into more complex blocks without departing from the scope of the provided method.

The accompanying drawings are used to help easily understand various technical features and it is understood that the embodiments presented herein are not limited by the accompanying drawings. As such, the provided method is construed to extend to any alterations, equivalents and substitutes in addition to those which are particularly set out in the accompanying drawings. Although the terms first, second, etc. used herein to describe various elements, these elements should not be limited by these terms. These terms are generally used to distinguish one element from another.

There is a requirement in 3GPP, which states that when there are multiple non-3GPP devices connected behind one UE/5G-RG then how those devices may get differentiated service from the network. In the provided solution, for each non-3GPP devices connected behind one UE/5G-RG, the UE/5G-RG may provide a non-3GPP device identifier to a session management function (SMF) in a PDU session request message. For instance, the PDU session request message includes a PDU session establishment request message or a PDU session modification request message. Then SMF then sends the non-3GPP device identifier to the PCF. The PCF may use the non-3GPP device identifier to apply a differentiated policy by fetching the information from the unified data repository (UDR).

By enhancing the fifth generation system (5GS) to allow for the creation and utilization of user-specific identities, operators may be able to provide enhanced user experience, optimized performance, and offer services to devices and users that are not part of the operator's 3rd generation partnership project (3GPP) network. For example, network settings can be adapted and services can be offered to users according to users' needs, different from the subscription identifier that is used by the user to establish the connection.

In an embodiment, the user to be identified could be an individual human user using the UE with a certain subscription, an application running on or connecting via a UE, or a device (e.g., a pin element (PINE)) behind a gateway UE (e.g., a pin element with gateway capability (PEGC)).

Use cases are thoroughly discussed and key issues (KIs) have been added to 3GPP standard specification TR 23.700-32:

The key issue focuses on how to support identifying the human user of a UE's 3GPP subscription when the human user access services via the 5GS using a user identifier. Solutions to this key issue may address:
whether and how the 5GC supports identifying the User Identifier that is associated with a UE's traffic,
requirements related to the User Identifiers e.g., scope of uniqueness and how they are assigned,
what information is stored as part of the User Identity Profile (e.g., a User Identifier, associated security credentials, associated devices, user specific QoS settings). Including how User Identity Profiles are created/acquired, stored, and updated,
whether and how User Identifiers are linked and unlinked (i.e., associated) with 3GPP subscriptions in an operator-controlled manner, and.
whether and how user specific policies, e.g., QoS settings, are taken into account by the 5GS in order to provide service differentiation.

In an embodiment, consider the scenario where some user identifiers are configured like (user1, user2 etc.) and UE is registering with the network. Then 5GC needs to authenticate these user identifiers before the 5GC allows the user identifiers to avail the service from the network. It is assumed that the user identifiers have been authenticated successfully. Now, one service provider/AF may have different service characteristic when two different user like user1 and user2 is invoking it. Hence it is provided that application function (AF) using the network exposure function (NEF) may configure different service profile like quality of service (QoS), bit rate, latency for each user identifier while creating the user profile. As the user identifier can be same if provided by two different AF, hence either NEF or unified data management (UDM) may create a mapping of user identifier to General Public user identifier (GPUI) and store these user profiles in user data repository (UDR).

Even though the user identifier mapping to GPUI is created by NEF or UDM, the mapping information can be sent to UDR as well along with user profiles. After successful creation of these user profiles, NEF may provide the GPUI to AF so that in future whenever AF updates any user profile information, this GPUI can be provided by AF. When one of the user like user1 triggers PDU session to get one service, it is provided that all the NF selection like access and mobility management function (AMF), SMF, policy control function (PCF), user plane function (UPF) etc. may be done which supports the user identifier feature. Once the protocol data unit (PDU) session request is received at AMF and SMF selection is done, then the AMF can provide the user identifier to SMF. SMF fetch the user identifier either received from AMF or from UE as part of the PDU session establishment request or PDU session modification request and use this information to select PCF (SM-PCF) and UPF.

Also, it is provided that the SMF provides this user identifier to the PCF and the UPF so that the PCF and UPF can apply the policies based on the user identifier, like PCF may provide the SM polices based on the user identifier to UE. It is also provided that the PCF and UPF subscribe to the UDR for any user identifier related user profile changes by providing the user identifier. The UDR may have the mapping of user identifier to GPUI and based on that whenever any changes done by AF by providing GPUI and successfully updated in UDR, the same modification is notified by UDR to PCF, UPF etc.

Similarly, it may happen that some policies may be updated by the AF, which is applicable for access management and UE like AM policy and UE policy. Hence, the AM-PCF and UE-PCF subscribe to the UDR for any user identifier related user profile changes by providing the user identifier. The UDR may have the mapping of the user identifier to the GPUI and based on that whenever any changes done by the AF by providing GPUI and successfully updated in the UDR, the same modification is notified by the UDR to the PCF.

In an embodiment, it is explained that the third Party/AF may create and update the user profile through NEF parameter provisioning service (Nnef_ParameterProvision_Create/Update service operation). It is also provided that the AF may use Nnef_AF_request_for_QoS Create/update service operation for creating or updating any QoS for the user identifier. Also, the AF can use Nnef_AFsessionWithQoS Create/update service operation.

FIG. 1 illustrates a first network apparatus (102) according to an embodiment as disclosed herein. For instance, the first network apparatus (102) corresponds to a SMF node.

The first network apparatus (102) includes various hardware and software components that facilitate communication between user equipment and network infrastructure. Examples of the first network apparatus (102) can include, but is not limited to base stations (such as macro cells, small cells, femtocells, picocells, etc.) for wireless communication, Antennas and RF Units (e.g., MIMO, beamforming) to enhance signal coverage and data throughput, core network equipment (e.g., MMEs, S-GWs, P-GWs in 4G; AMFs, UPFs in 5G) for data routing, mobility, and session control, network function virtualization (NFV) and software-defined networking (SDN) for dynamic resource allocation and scalability, EDGE computing nodes (e.g., MEC servers) for low-latency processing, backhaul and transport equipment (e.g., fiber-optic links, microwave relays, Ethernet switches) to connect base stations to the core network, network management systems (NMS) and operation support systems (OSS) for network configuration, fault management, and optimization, radio network controllers (RNCs) in 3G, distributed units (DUs), and centralized units (CUs) in 5G, network slicing components for virtualized resource allocation, security elements (e.g., firewalls, IDS, AAA servers) for secure communication.

In an embodiment, FIG. 1, the first network apparatus (102) includes a first processor (104), a first memory (106), a first I/O interface (108), and a first differentiated service controller (110) coupled to the first processor (104) and the first memory (106). The components are explained in further detail below.

The first processor (104) communicates with the first memory (106), the first I/O interface (108), and the first differentiated service controller (110). The first processor (104) is configured to execute instructions stored in the first memory (106) and to perform various processes. The first processor (104) includes one or a plurality of processors, is a general-purpose processor such as a central processing unit (CPU), an application processor (AP), or the like, a graphics-only processing unit such as a graphics processing unit (GPU), a visual processing unit (VPU), and/or an artificial intelligence (AI) dedicated processor such as a neural processing unit (NPU).

The first memory (106) includes storage locations to be addressable through the first processor (104). The first memory (106) is not limited to a volatile memory and/or a non-volatile memory. Further, the first memory (106) includes a plurality of computer-readable storage media. The first memory (106) includes non-volatile storage elements. For example, non-volatile storage elements includes magnetic hard disks, optical disks, floppy disks, flash memories, or forms of electrically programmable memories (EPROM) or electrically erasable and programmable (EEPROM) memories.

The first I/O interface (108) transmits the information between the first memory (106) and external peripheral devices. The peripheral devices are the input-output devices associated with the first network apparatus (102). Further, the first differentiated service controller (110) communicates with the first I/O interface (108) and the first memory (106). The first differentiated service controller (110) is coupled to the first memory (106) and the first processor (104). The first differentiated service controller (110) is innovative hardware that are realized through the physical implementation of both analog and digital circuits, including logic gates, integrated circuits, microprocessors, microcontrollers, memory circuits, passive and active electronic components, as well as optical components.

In an embodiment, the first differentiated service controller (110) receives a protocol data unit (PDU) session request message from the UE or the AMF. The PDU session request message includes a non-3GPP device identifier and a user plane address of the non-3GPP devices associated with the UE or the 5G-RG. Non-3GPP devices refer to devices that do not operate on traditional 3GPP standards. For example, the non-3GPP devices include, but not limited to IoT sensors, smart home appliances, or other types of networked equipment. The user plane address routes data packets to and from the non-3GPP devices, ensuring that they can communicate effectively with the communication network. The user plane address serves as a unique identifier for the data path, allowing the first differentiated service controller (110) to manage traffic flows and apply appropriate QoS policies based on the specific needs of the non-3GPP devices associated with the UE or the 5G-RG.

Examples of the UE (302) can include, but are not limited to, consumer electronics (such as mobile phones and smartphones), tablets, wearable devices, computing devices (such as laptops, notebooks, desktops, workstations, etc.), IoT devices, automotive systems (such as connected cars, autonomous vehicles, vehicle-to-everything (V2X) communication devices, etc.), enterprise devices such as robotics, specialized equipment (such as medical devices, public safety devices, etc.), media devices (such as gaming consoles, streaming devices, etc.). Examples of the 5G-RG include modem-router combos, standalone gateways, fiber optic gateways, 5G or LTE gateways, DSL gateways, IOT gateways, and the like.

In an embodiment, the first differentiated service controller (110) detects whether a policy control request trigger is met. The policy control request trigger is responsible for creating, managing, and enforcing network policies. For instance, the policy control request trigger is based on a predefined condition related to an activity or a state of the non-3GPP device

In an embodiment, the first differentiated service controller (110) detects at least one of a PCF node and a UPF node of the second network apparatus, which supports QoS differentiation. The PCF node is responsible for defining and enforcing policies related to network resource allocation and service quality. It ensures that the appropriate QoS parameters are applied based on the specific requirements of different types of traffic or user sessions. Further, the UPF node handles the actual data traffic within the communication network. It manages the forwarding of user data packets and is essential for the implementation of QoS measures. The first differentiated service controller (110) selects at least one of the PCF node and the UPF node of the second network apparatus based on the non-3GPP device identifier. The selection is performed upon detection of the policy control request trigger. The first differentiated service controller (110) then transmits the non-3GPP device identifier and the user plane address of the non-3GPP device to at least one of the PCF node and UPF node.

In an embodiment, the first differentiated service controller (110) receives one or more policy and charging control (PCC) rules from the PCF node or the UPF node based on the non-3GPP device identifier. The PCC rules define how various data flows are treated within the communication network. The rules can be obtained from either the PCF node or the UPF node, depending on the requirements of the communication network. The PCF node is responsible for managing policy decisions and ensuring that the network adheres to the defined service level agreements. The UPF node handles the actual data forwarding and user plane traffic management.

In an embodiment, the first differentiated service controller (110) establishes/enables QoS handling of traffic to and from the non-3GPP device associated with the UE or the 5G-RG based on the PCC rules. The first differentiated service controller (110) assesses specific QoS requirements of each type of traffic, which can vary based on factors such as the type of application being used, the priority of the data, and the overall network conditions. By following the PCC rules, the first differentiated service controller (110) ensures that the QoS handling aligns with the policies set by the network operator. These policies may mention factors such as, how bandwidth is allocated, how latency is managed, how different types of traffic are prioritized, and the like.

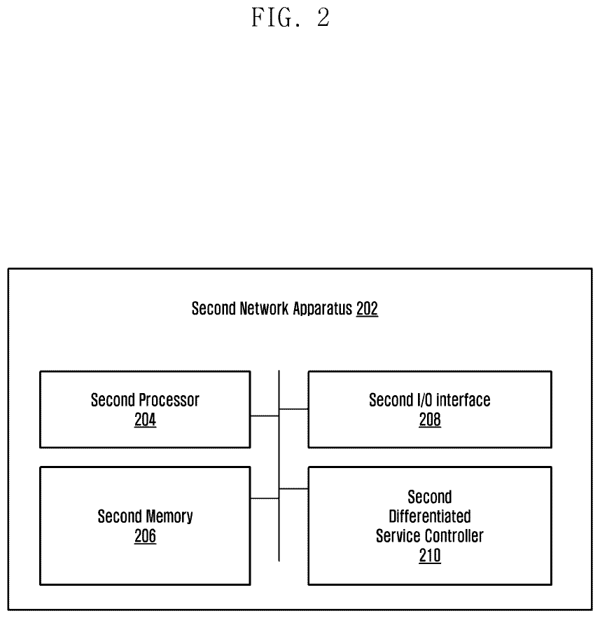

FIG. 2 illustrates a second network apparatus (202) according to an embodiment as disclosed herein. For instance, the second network apparatus (202) corresponds to a PCF node and a UPF node.

The second network apparatus (202) includes various hardware and software components that facilitate communication between user equipment and network infrastructure. Examples of the second network apparatus (202) can include, but is not limited to base stations (such as macro cells, small cells, femtocells, picocells, etc.) for wireless communication, Antennas and RF Units (e.g., MIMO, beamforming) to enhance signal coverage and data throughput, core network equipment (e.g., MMEs, S-GWs, P-GWs in 4G; AMFs, UPFs in 5G) for data routing, mobility, and session control, network function virtualization (NFV) and software-defined networking (SDN) for dynamic resource allocation and scalability, EDGE computing codes (e.g., MEC servers) for low-latency processing, backhaul and transport equipment (e.g., fiber-optic links, microwave relays, Ethernet switches) to connect base stations to the core network, network management systems (NMS) and operation support systems (OSS) for network configuration, fault management, and optimization, radio network controllers (RNCs) in 3G, Distributed units (DUs), and centralized units (CUs) in 5G, network slicing components for virtualized resource allocation, security elements (e.g., firewalls, IDS, AAA servers) for secure communication.

In an embodiment, FIG. 2, the second network apparatus (202) includes a second processor (204), a second memory (206), a second I/O interface (208), and a second differentiated service controller (210) coupled to the second processor (204) and the second memory (206). Further, the second differentiated service controller (210) communicates with the second I/O interface (208) and the second memory (206). The second differentiated service controller (210) is coupled to the second memory (206) and the second processor (204). The second differentiated service controller (210) is innovative hardware that are realized through the physical implementation of both analog and digital circuits, including logic gates, integrated circuits, microprocessors, microcontrollers, memory circuits, passive and active electronic components, as well as optical components.

In an embodiment, the second differentiated service controller (210) receives a non-3GPP device identifier of a non-3GPP device connected behind the UE or the 5G-RG from the first network apparatus (102). The non-3GPP device identifier refers to an identifier used to recognize and manage non-3GPP devices that connect to the communication network through non-3GPP access technologies. For instance, the non-3GPP device identifier includes a media access control (MAC) address, a network access identifier (NAI), private identifiers, public identifiers, and the like.

In an embodiment, the second differentiated service controller (210) generates PCC rules based on the at least one non-3GPP device identifier. The PCC rules refer to a set of policies defined to manage and control network traffic, QoS, and charging mechanisms for user sessions. For instance, the PCC rules may include traffic flow descriptors (TFDs), QoS parameters, charging rules, activation conditions, and the like. The PCC rules generated can include dynamic PCC rules and static PCC rules. Dynamic PCC rules are applied for specific sessions or services that initiated or modified, and static PCC rules are used for standard or recurring traffic patterns. The second differentiated service controller (210) then transmits the one or more PCC rules to the first network apparatus to enable QoS handling of traffic to and from the non-3GPP device associated with the UE or the 5G-RG.

In an embodiment, the second differentiated service controller (210) retrieves information associated with the non-3GPP device identifier from the UDR based on the non-3GPP device identifier received from first network apparatus (102). For instance, the information includes a service description and service parameters. The service description contains an AF-service-identifier indicating that the request is for providing non-3GPP device identifier information. The service parameters includes the non-3GPP device identifier information such as QoS reference parameters. The UDR holds essential data that can help the second differentiated service controller (210) make informed decisions regarding service delivery, quality of service, and overall network performance. The UDR simplifies data handling by consolidating user data in a single repository.

In an embodiment, the second differentiated service controller (210) updates the one or more PCC rules based on the retrieved information. Once updated, the second differentiated service controller (210) transmits the updated PCC rules to the first network apparatus (102) to enable the QoS handling of traffic to and from the non-3GPP device associated with the UE.

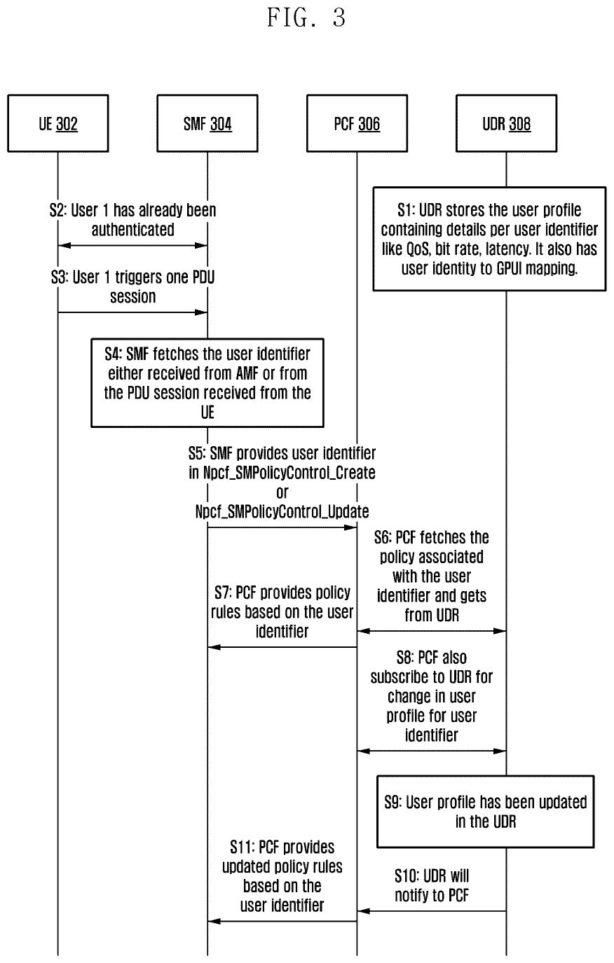

FIG. 3 illustrates a procedure executed by 5GC ensuring that differentiated services are provided based on the user identifier according to an embodiment as disclosed herein. As shown in the sequence diagram, a UE (302), a SMF (304), a PCF (306), and a UDR (308) are in communication with each other. At step 1, the UDR (308) has already stored the user profile containing details per user identifier like QoS, bit rate, latency. The UDR (308) also has user identifier to GPUI mapping.

At step 2, the user 1 that is configured on UE1/UE (302) has been already authenticated. At step 3, the user1 using the UE (302) triggers one PDU session with the SMF (304). At step 4, the SMF (304) fetches the user identifier either received from the AMF or from the PDU session received from the UE (302). At step 5, the SMF (304) provides the user identifier in Npcf_SMPolicyControl_Create or Npcf_SMPolicyControl_Update request to the PCF (306). At step 6, the PCF (306) fetches the policy associated with the user identifier and gets from the UDR (308).

At step 7, the PCF (306) provides policy based on the user identifier to the SMF (304). At step 8, the PCF (306) also subscribe to the UDR (308) for any change in user profile for the user identifier. At step 9, the user profile is updated in the UDR (308). At step 10, the UDR (308) may notify to the PCF (306) regarding the update of the user profile. At step 11, the PCF (306) provides the updated policy based on the user identifier to SMF (304). The above solutions are applicable for third party or application functions provided user identifier.

The use cases of differentiated service based on the user identifier also applicable for operator provided user identifier. In this case as operator provides the user identifier, operator can ensure unique identifier is assigned. Hence, the solution explained for third party/AF provided user identifier is also applicable here except that there may not be any mapping of user identifier to the GPUI.

The Network used in this embodiment is explained using any 5G Core Network Function for e.g., AMF. However, the network could be any 5G/EUTRAN Core Network Entities like the AMF/SMF (304)/MME/UPF or the Network could be any 5G/EUTRAN RAN Entity like eNodeB (eNB) or gNodeB (gNB) or NG-RAN etc.

The messages used or indicated in this embodiment are shown as an example. The messages could be any signalling messages between the UE (302) and the Network Functions/Entities or between different Network functions/entities. Similarly, the service operation name given in this disclosure is illustration purposes only. Any other name can be used to convey the information.

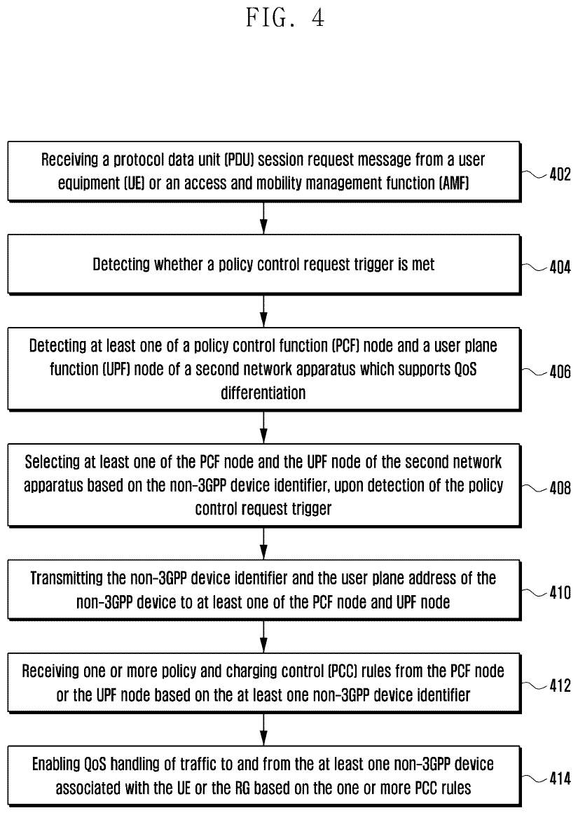

FIG. 4 illustrates a method for managing a QoS for a non-3GPP device in a communication network by the first network apparatus (102) according to an embodiment as disclosed herein. The method includes steps (402-414). Each step is explained in further detail below.

In step (402), the first network apparatus (102) receives a protocol data unit (PDU) session request message from the UE (302) or the AMF. The PDU session request message includes a non-3GPP device identifier and a user plane address of the non-3GPP devices associated with the UE (302) or the 5G-RG. Non-3GPP devices refer to devices that do not operate on traditional 3GPP standards. For example, the non-3GPP devices include, but not limited to IoT sensors, smart home appliances, or other types of networked equipment. The user plane address directs data packets to and from non-3GPP devices, facilitating effective communication with the communication network. The user plant address acts as a distinct identifier for the data route, enabling the first network apparatus (102) implement suitable QoS policies based on the specific requirements of the non-3GPP devices linked to the UE (302) or the 5G-RG.

In step (404), the first network apparatus (102) detects a PCF mode and a UPF node of the second network apparatus (202), which supports QoS differentiation. In step (406), the first network apparatus (102) detects at least one of the PCF node and the UPF node of the second network apparatus (202) based on the non-3GPP device identifier, upon detection of the policy control request trigger. The PCF node is responsible for defining and enforcing policies related to network resource allocation and service quality. It ensures that the appropriate QoS parameters are applied based on the specific requirements of different types of traffic or user sessions. Further, the UPF node handles the actual data traffic within the communication network. It manages the forwarding of user data packets and is essential for the implementation of QoS measures.

In step (408), the first network apparatus (102) selects at least one of the PCF node and the UPF node of the second network apparatus (202) based on the non-3GPP device identifier. The selection is performed upon detection of the policy control request trigger. In step (410), the first network apparatus (102) then transmits the non-3GPP device identifier and the user plane address of the non-3GPP device to at least one of the PCF node and UPF node.

In step (412), the first network apparatus (102) receives one or more PCC rules from the PCF node or the UPF node based on the non-3GPP device identifier. The PCC rules define how various data flows are treated within the communication network. The rules can be sourced from either the PCF node or the UPF node, depending on the requirements of the communication network. The PCF node is responsible for managing policy decisions and ensuring that the network adheres to the defined service level agreements. The UPF node handles the actual data forwarding and user plane traffic management.

In step (414), the first network apparatus (102) enables QoS handling of traffic to and from the non-3GPP device associated with the UE (302) or the 5G-RG based on the PCC rules. The first network apparatus (102) assesses specific QoS requirements of each type of traffic, which can vary based on factors such as the type of application being used, the priority of the data, and the overall network conditions. By following the PCC rules, the first network apparatus (102) ensures that the QoS handling aligns with the policies set by the network operator. These policies may dictate how bandwidth is allocated, how latency is managed, and how different types of traffic are prioritized.

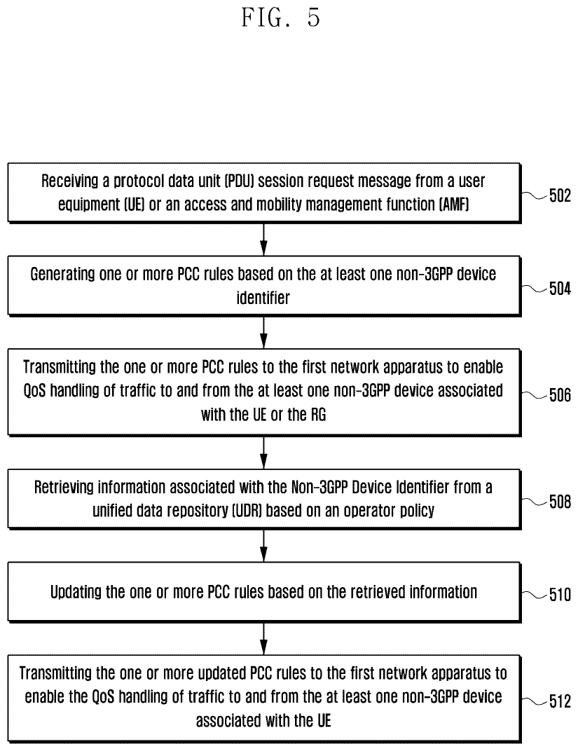

FIG. 5 illustrates a method for managing a QoS for a non-3GPP device in a communication network by the second network apparatus (202) according to an embodiment as disclosed herein. The method includes steps (502-512). Each step is explained in further detail below.

In step (502), the second network apparatus (202) receives a non-3GPP device identifier of a non-3GPP device connected behind the UE (302) or the 5G-RG from the first network apparatus (102). The non-3GPP device identifier refers to an identifier used to recognize and manage non-3GPP devices that connect to the communication network through non-3GPP access technologies. For instance, the non-3GPP device identifier includes a media access control (MAC) address, a network access identifier (NAI), private identifiers, public identifiers, and the like.

In step (504), the second network apparatus (202) generates PCC rules based on the at least one non-3GPP device identifier. The PCC rules refer to a set of policies defined to manage and control network traffic, QoS, and charging mechanisms for user sessions. For instance, the PCC rules may include TFDs, QOS parameters, charging rules, activation conditions, and the like. The generated PCC rules can be categorized into dynamic and static types. Dynamic PCC rules are utilized for particular sessions or services that have been initiated or altered, while static PCC rules are employed for consistent or recurring traffic patterns. In step (506), the second differentiated service controller (210) sends the relevant PCC rules to the first network apparatus, facilitating QoS management for traffic to and from the non-3GPP device linked to the UE (302) or the 5G-RG.

In step (508), the second network apparatus (202) retrieves information associated with the non-3GPP device identifier from the UDR (308) based on the non-3GPP device identifier received from first network apparatus (102). For instance, the information includes a service description and service parameters. The service description contains an AF-service-identifier indicating that the request is for providing non-3GPP device identifier information. The service parameters includes the non-3GPP device identifier information such as QoS reference parameters. The UDR (308) holds essential data that can help the second differentiated service controller (210) make informed decisions regarding service delivery, quality of service, and overall network performance. The UDR (308) simplifies data handling by consolidating user data in a single repository.

In step (510), the second network apparatus (202) updates the PCC rules based on the retrieved information. Once updated, in step (512), the second network apparatus (202) transmits the updated PCC rules to the first network apparatus (102). This enables the QoS handling of traffic to and from the non-3GPP device associated with the UE (302).

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a session management function (SMF) for managing quality of service (QOS) differentiation of a non-3GPP devices in a communication network, the method comprising:
receiving, from a user equipment (UE), a protocol data unit (PDU) session request message, wherein the PDU session request message comprises a non-3GPP device identifier and a user plane address of at least one non-3GPP device associated with the UE;
triggering a modification operation for a PDU session; and
transmitting, to a policy control function (PCF), the non-3GPP device identifier and the user plane address of the at least one non-3GPP device.

2. The method of claim 1, wherein the PDU session request message comprises one of a PDU session establishment request message or a PDU session modification request message.

3. The method of claim 1, further comprising:
receiving, from the PCF, one or more policy and charging control (PCC) rules determined based on the non-3GPP device identifier; and
enabling a QoS handling operation for traffic of the at least one non-3GPP device associated with the UE based on the one or more PCC rules.

4. The method of claim 1, wherein the non-3GPP device identifier identifies the at least one non-3GPP device behind a subscription of the UE.

5. The method of claim 1, wherein the modification operation of the PDU session is triggered based on a predefined condition related to an activity or a state of the at least one non-3GPP device.

6. A method performed by a policy control function (PCF) for managing QoS differentiation of a non-3GPP device in a communication network, the method comprising:
receiving, from a session management function (SMF), a non-3GPP device identifier of at least one non-3GPP device connected behind a user equipment (UE);
generating one or more policy and charging control (PCC) rules based on the at least one non-3GPP device identifier; and
transmitting, to the SMF, the one or more PCC rules to enable a QoS handling operation for traffic of the at least one non-3GPP device associated with the UE.

7. The method of claim 6, further comprising:
retrieving, from a unified data repository (UDR), information associated with the non-3GPP device identifier;
updating the one or more PCC rules based on the retrieved information; and
transmitting, to the SMF, the one or more updated PCC rules to enable the QoS handling operation for traffic of the at least one non-3GPP device associated with the UE.

8. The method of claim 6, further comprising:
generating a subscription message for the UDR, the subscription message requesting for a change in a user profile associated with the non-3GPP device identifier;
receiving an updated policy that comprises information updated in the user profile by the UDR based on the subscription message;
updating the one or more PCC rules based on the updated policy information; and
transmitting, to the SMF, the updated policy information, wherein the updated policy information is modified by third party or application functions (AFs) associated with the non-3GPP device identifier.

9. A session management function (SMF) for managing quality of service (QOS) differentiation of a non-3GPP device in a communication network, the SMF comprising:
a transceiver; and
a controller communicatively coupled to the transceiver, the controller configured to:
receives, from a user equipment (UE), a PDU session establishment request message, wherein the PDU session establishment request message comprises a non-3GPP device identifier and a user plane address of at least one non-3GPP device associated with the UE,
trigger a modification operation for a PDU session, and
transmit, to a policy control function (PCF), the non-3GPP device identifier and the user plane address of the at least one non-3GPP device.

10. The SMF of claim 9, wherein the PDU session request message comprises one of a PDU session establishment request message or a PDU session modification request message.

11. The SMF of claim 9, wherein the controller is further configured to:
receive, from the PCF, one or more policy and charging control (PCC) rules determined based on the non-3GPP device identifier; and
enable a QoS handling operation of traffic for the at least one non-3GPP device associated with the UE based on the one or more PCC rules.

12. The SMF of claim 9, wherein the non-3GPP device identifier identifies the at least one non-3GPP device behind a subscription of the UE.

13. The SMF of claim 9, wherein the modification operation of the PDU session is triggered based on a predefined condition related to an activity or a state of the at least one non-3GPP device.

14. A policy control function (PCF) for managing quality of service (QOS) differentiation of a non-3GPP device in a communication network, the PCF comprising:
a transceiver; and
a controller communicatively coupled to the transceiver, the controller configured to:
receive, from a session management function (SMF), a non-3GPP device identifier of at least one non-3GPP device connected behind a user equipment (UE),
generate one or more policy and charging control (PCC) rules based on the at least one non-3GPP device identifier, and
transmit, to the SMF, the one or more PCC rules to enable a QoS handling operation for traffic of the at least one non-3GPP device associated with the UE.

15. The PCF of claim 14, wherein the controller is further configured to:
retrieve, from a unified data repository (UDR), information associated with the non-3GPP device identifier,
update the one or more PCC rules based on the retrieved information, and
transmit, to the SMF, the one or more updated PCC rules to enable the QoS handling operation for traffic of the at least one non-3GPP device associated with the UE.

16. The PCF of claim 14, wherein the controller is further configured to:
generate a subscription message for the UDR, the subscription message requesting for a change in a user profile associated with the non-3GPP device identifier;
receive an updated policy that comprises information updated in the user profile by the UDR based on the subscription message;
update the one or more PCC rules based on the updated policy information; and
transmit, to the SMF, the updated policy information, wherein the updated policy information is modified by third party or application functions (AFs) associated with the non-3GPP device identifier.
